(19) United States
(12) Patent Application Publication
(10) Pub. No.: US 2009/0089190 A1
(43) Pub. Date: Apr. 2, 2009

(54) SYSTEMS AND METHODS FOR MONITORING FINANCIAL ACTIVITIES OF CONSUMERS

(76) Inventor: Rollin M. Girulat, JR., Lake Forest, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/239,647

(22) Filed: Sep. 26, 2008

Related U.S. Application Data
(60) Provisional application No. 60/975,754, filed on Sep. 27, 2007.

(51) Int. Cl. G06Q 40/00; G06Q 10/00; G06F 17/30

(52) U.S. Cl. 705/30; 705/38; 707/5; 705/36 R; 707/E17.016

(57) ABSTRACT

Systems and methods are disclosed for monitoring consumer financial data. Clients such as financial institutions or debt buyers identify one or more consumers for which monitoring is desired. Historical financial data, such as credit data, is periodically compared with current financial data according to a number of logical rules or financial triggers. The financial triggers correspond to improvements in a financial position of a consumer. When a financial improvement is determined according to the logical rules, an alert is generated and sent to the client, allowing the client to adjust a collection strategy.

### CROSS-REFERENCE TO RELATED APPLICATIONS

This application claims the benefit of priority from U.S. Provisional Patent Application No. 60/975,754 filed on Sep. 27, 2007, entitled “Systems and Methods for Monitoring Credit Activity Changes and Generating Alerts,” the entire contents of which are hereby incorporated herein by reference in their entirety. All publications and patent applications mentioned in this specification are herein incorporated by reference in their entirety to the same extent as if each individual publication or patent application was specifically and individually indicated to be incorporated by reference.

### TECHNICAL FIELD

This disclosure relates generally to financial data processing, and more particularly to methods and systems for identifying improvements in consumer financial positions and generating client alerts.

### DESCRIPTION OF THE RELATED ART

Various financial service providers provide credit accounts such as mortgages, automobile loans, credit card accounts, and the like, to consumers. Some of these consumers experience financial difficulties and are unable to meet the obligations associated with their credit accounts. These financial difficulties often extend for several years. After a period of unsuccessful collection efforts, the financial service providers that originally extended credit to these consumers (or collection agencies and/or debt buyers that have acquired the accounts) may make an economic decision to abandon collection efforts. Many consumers who experience financial difficulties, even for several years, eventually improve their economic situation to the extent that they would be able to make payments towards their outstanding debt. However, they are unlikely to do so without some collection effort by the financial service providers, collection agencies, or debt buyers.

### SUMMARY OF THE INVENTION

A system is described to provide financial improvement alerts to a financial service provider (which may include the creditor that originally granted credit to the consumer, a collection agency, a debt buyer, or any other entity that is involved in the collection effort) indicating changes in a consumer's financial data that are indicative of an increase in the consumer's ability to repay at least a portion of their outstanding debt. As used herein, the term “financial data” may include any type of financial data, such as credit data, debit data, bank records, public records, and/or any other data that may be used in order to identify an improvement in the consumer's financial position.

These financial improvement alerts may be transmitted to the financial service provider in order to signal the provider that the consumer may be in a better position to repay his or her outstanding debt. Thus, in response to receiving a financial improvement alert for a particular consumer, a creditor (or other financial service provider) may determine that collection efforts should be initiated and/or increased in view of the indicated improvement in the consumer financial profile. According to one embodiment, a computer system monitors a consumer's financial data, determines when that consumer has engaged in activities indicating a financial improvement, and then generates an alert for certain financial service providers.

According to one embodiment, a financial service provider or collection agency identifies at least one consumer to be monitored for financial improvement. Financial data is collected and monitored for the identified consumers. Current financial data may be compared with historical financial data for the identified consumers according to one or more rules. The rules comprise financial improvement triggers that are activated when a consumer engages in an activity that represents an improved economic condition and/or the ability to repay existing debt. When one of the triggers is activated for a monitored consumer, an alert is generated and sent to any financial service provider or collection agency that had requested monitoring of the consumer.

One embodiment is a computer implemented method for generating an alert based on consumer financial data, the method comprising: receiving from a financial service provider a request to monitor a consumer for financial improvements that are indicative of an increased likelihood that the consumer will pay an outstanding debt, the request comprising at least a name and address of a consumer for monitoring; accessing first financial data associated with the consumer, the first financial data comprising data for each of one or more financial accounts associated with the consumer at a first time; accessing second financial data associated with the consumer, the second financial data comprising data for each of one or more financial accounts associated with the consumer at a second time, wherein the second time is later than the first time; comparing the first and second financial data to determine whether a predetermined difference exists between the first financial data and the second financial data, the predetermined difference representing an improvement in one or more of the financial accounts between the first time and the second time such that the consumer appears to be in a better position to make payments towards the outstanding debt; and generating an alert for transmission to the financial service provider.

Another embodiment is a computer system for generating alerts based on consumer financial activity, the computer system comprising: a financial database that stores current financial data; a historical database that stores historical credit data; and a trigger module. The trigger module is configured to receive a list of consumers to monitor; access the financial database on a periodic basis and retrieve the current financial data for consumers on the list; for each consumer, compare the current financial data against the historical financial data stored in the historical database to determine if any differences in the current and historical financial data are indicative of financial improvement for the consumer; and generate a financial improvement alert indicating those zero or more consumers for which the current and historical financial data are indicative of financial improvement.

These and additional embodiments are discussed in greater detail below. Numerous other advantages and features of the present invention will become readily apparent from the following detailed description of the invention and the embodiments thereof, from the claims and from the accompanying drawings.

### BRIEF DESCRIPTION OF THE DRAWINGS

The objects, features and advantages of the present invention will be more readily appreciated upon reference to the following disclosure when considered in conjunction with the accompanying drawings and examples which form a portion of the specification, in which:

FIG. 1 is a block diagram of a system for tracking changes in consumer financial data and generating financial improvement alerts according to one embodiment;

FIG. 2 shows sources of financial data in a financial database according to one embodiment;

FIG. 3 is a flowchart showing a process for determining whether a financial improvement trigger has been activated and generating alerts;

FIG. 4A shows a current financial database record according to one embodiment;

FIG. 4B shows a historical financial database record according to one embodiment; and

FIG. 5 is a flowchart showing another process for determining whether a financial improvement trigger has been activated and generating alerts.

### DETAILED DESCRIPTION OF THE PREFERRED EMBODIMENT

Embodiments of the invention will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

### Computer Hardware Embodiments

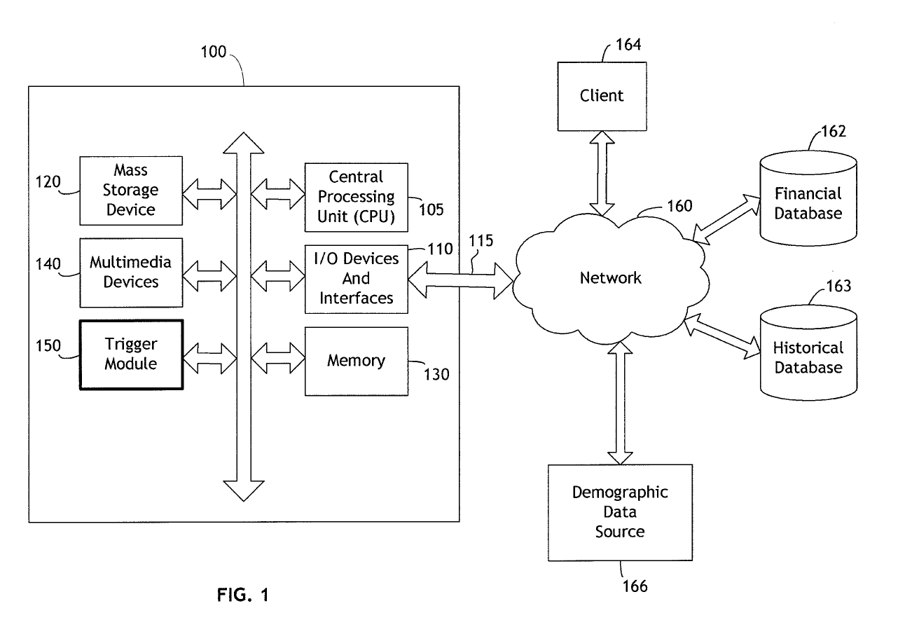

FIG. 1 is one embodiment of a block diagram of a computing system 100 that is in communication with a network 160 and various devices that are also in communication with the network 160. The computing system 100 may be used to implement certain systems and methods described herein. For example, the computing system 100 may be configured to receive financial and demographic information regarding individuals and generate reports and/or alerts for one or more clients (e.g., financial service providers, such as creditor originators, collection agencies, debt buyers, or any other entities that would be interested in learning of improvements in the financial situations of particular consumers). Although the description provided herein refers to individuals, consumers, or customers, the terms “individual,” “consumer,” and “customer” should be interpreted to include applicants, or groups of individuals or customers or applicants, such as, for example, married couples or domestic partners, and business entities. The functionality provided for in the components and modules of computing system 100 may be combined into fewer components and modules or further separated into additional components and modules.

The computing system 100 may include, for example, a personal computer that is IBM, Macintosh, or Linux/Unix compatible. In one embodiment, the computing system 100 comprises a server, a laptop computer, a cell phone, a personal digital assistant, a kiosk, or an audio player, for example. In one embodiment, the exemplary computing system 100 includes a central processing unit (“CPU”) 105, which may include a conventional microprocessor. The computing system 100 further includes a memory 130, such as random access memory (“RAM”) for temporary storage of information and a read only memory (“ROM”) for permanent storage of information, and a mass storage device 120, such as a hard drive, diskette, or optical media storage device. Typically, the modules of the computing system 100 are connected to the computer using a standards based bus system. In different embodiments, the standards based bus system could be Peripheral Component Interconnect (PCI), Microchannel, SCSI, Industrial Standard Architecture (ISA) and Extended ISA (EISA) architectures, for example.

The computing system 100 is generally controlled and coordinated by operating system software, such as Windows 95, Windows 98, Windows NT, Windows 2000, Windows XP, Windows Vista, Linux, SunOS, Solaris, or other compatible operating systems. In Macintosh systems, the operating system may be any available operating system, such as MAC OS X. In other embodiments, the computing system 100 may be controlled by a proprietary operating system. Conventional operating systems control and schedule computer processes for execution, perform memory management, provide file system, networking, I/O services, and provide a user interface, such as a graphical user interface (“GUI”), among other things.

The exemplary computing system 100 may include one or more commonly available input/output (I/O) devices and interfaces 110, such as a keyboard, mouse, touchpad, and printer. In one embodiment, the I/O devices and interfaces 110 include one or more display device, such as a monitor, that allows the visual presentation of data to a user. More particularly, a display device provides for the presentation of GUIs, application software data, and multimedia presentations, for example. The computing system 100 may also include one or more multimedia devices 140, such as speakers, video cards, graphics accelerators, and microphones, for example.

In the embodiment of FIG. 1, the I/O devices and interfaces 110 provide a communication interface to various external devices. In the embodiment of FIG. 1, the computing system 100 is coupled to a network 160, such as a LAN, WAN, or the Internet, for example, via a wired, wireless, or combination of wired and wireless, communication link 115. The network 160 communicates with various computing devices and/or other electronic devices via wired or wireless communication links. In one embodiment, the computing system 100 is in communication with certain devices, such as the financial database 162, demographic data source 166, and historical database 163, via a secured local area connection, while the computing system 100 is in communication with the client 164 via a combination of a local area network and the Internet.

According to FIG. 1, information is provided to computing system 100 over the network 160 from one or more data sources including, for example, one or more of the financial database 162, the historical database 163, the client 164, and the demographic data source 166. The information supplied by the various data sources may include credit data, demographic data, application information, product terms, accounts receivable data, and financial statements, for example. In addition to the devices that are illustrated in FIG. 1, the network 160 may communicate with other data sources or other computing devices. In addition, the data sources may include one or more internal and/or external data sources. In some embodiments, one or more of the databases or data sources may be implemented using a relational database, such as Sybase, Oracle, CodeBase and Microsoft® SQL Server as well as other types of databases such as, for example, a flat file database, an entity-relationship database, and object-oriented database, and/or a record-based database.

Client 164 may comprise, for example, a financial service provider, such as an originating creditor, a collection agency, and/or a debt buying entity. Although one client 164 is shown in FIG. 1, any number of clients 164 may communicate with the computing system 100 over the network 160. The client 164 may provide data related to consumer credit activity, such as opening new accounts, making payments on existing accounts, or the like. In addition to supplying data, client 164 may further request information from the computing system 100. For example, the client 164 may request financial improvement alerts for consumers monitored by the computing system 100. The client 164 may supply a list of consumers for whom monitoring is needed. For example, client 164 may comprises a retailer having thousands of customers including several hundred customers with 120 day past due account statuses. The retailer may generate a file listing these several hundred customers and transmit the list to the computing system 100 for monitoring for financial improvement. The file listing the customers for monitoring may be in any suitable file format, such as comma separate value (CSV), Extensible Markup Language (XML), or any other file format that is usable by the computing system 100.

The computing system of FIG. 1 also includes a trigger module 150 that is configured to access financial data of consumers and compare historical financial data of customers with current financial data of those consumers. For example, the trigger module 150 may receive a list of consumer's that the client 164 wishes to monitor for financial improvement. In response to this request (assuming the proper consumer identification information is provided and the client 164 has paid for the monitoring service), the trigger module 150 may periodically access the historical and current data for those consumers and compare the two sets of data for each consumer according to one or more financial improvement triggers (e.g., a set of logical rules) in order to identify consumers having an actual or predicted improvement in their ability and/or desire to pay existing and outstanding debt. For example, a financial improvement trigger may be activated when a consumer has brought an outstanding account from 90+ days past-due status to 30 days past-due status or better by making one or more payments.

In one embodiment, the trigger module 150 generates alerts that are transmitted to the client 164 when a financial improvement trigger is activated. The alert may be provided to the client 164 in various formats, such as an email, a file indicating alerts for each of a plurality of consumers (such as the list of several hundred consumer provided by the exemplary retailer noted above, with an indication as to which, if any, of the consumers match one or more financial improvement rules), a web interface, or any other suitable format. In general, an alert indicates to the client 164 that a consumer having accounts with outstanding debt, such as an account for which collection efforts have previously been abandoned, may now be a good target for renewed collection efforts. This module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

### Financial Databases and Data Sources

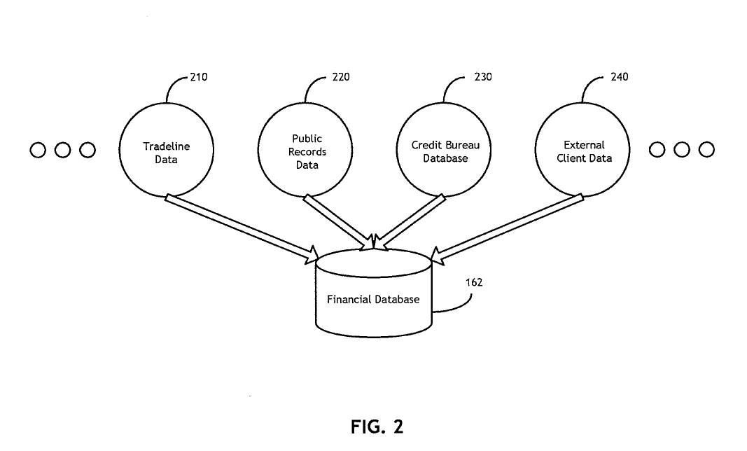

FIG. 2 shows a diagram illustrating that in one embodiment the financial database 162 comprises data obtained from various data sources, including but not limited to tradeline data 210, public records data 220, a credit bureau database 230, and external client data 240. In one embodiment, the financial database comprises consumer credit files that are maintained by a credit bureau. Depending on the embodiment, the financial database 162 may comprise multiple databases, or other data structures, that may be operated and/or controlled by different entities. In addition, the data may include externally stored and/or internally stored data. In certain embodiments, tradeline data 210 and public records data 220 is received by the credit bureau database 230. In other embodiments, the financial database 162 comprises only a subset of the data available from the various data sources set forth above. The data stored in the financial database 162 may be compiled and formatted by the computing system 100. For example, the computing system 100 may receive credit data from multiple sources such as the client 164 and the demographic data source 166. In one embodiment, the computing system 100 comprises a local copy, such as in the mass storage device 120 or a storage device that is accessible via a local area network, of at least a portion of the financial database 162. This local copy of the financial database 162 may be updated periodically, such as daily, weekly monthly, or at any other interval, in order to provide timely financial data to the trigger module 150.

The historical database 163 (FIG. 1) stores historical financial data. According to some embodiments, snapshots of financial database 162 at various times are stored in historical database 163. That is, before financial database 162 is updated with new credit data, for example once each month, the existing data is stored with a timestamp in historical database 163. Historical database 163 may store one or more such snapshots. For example, historical database 163 may store a snapshot of financial database 162 for every month, or historical database 163 may store only a previous month's snapshot. As described in more detail below, by comparing historical credit data stored in historical database 163 with current credit data stored in financial database 162, financial improvements may be determined. Depending on the embodiment, historical and financial databases 162, 163 may be stored on separate physical storage devices or may be both stored on common storage devices, such as a linked array of servers. In one embodiment, the computing system 100 comprises the historical database 163 or a local copy of at least a portion of the historical database 163 in the mass storage device 120 or a storage device that is accessible via a local area network.

### Monitoring Financial Activity and Generating Alerts

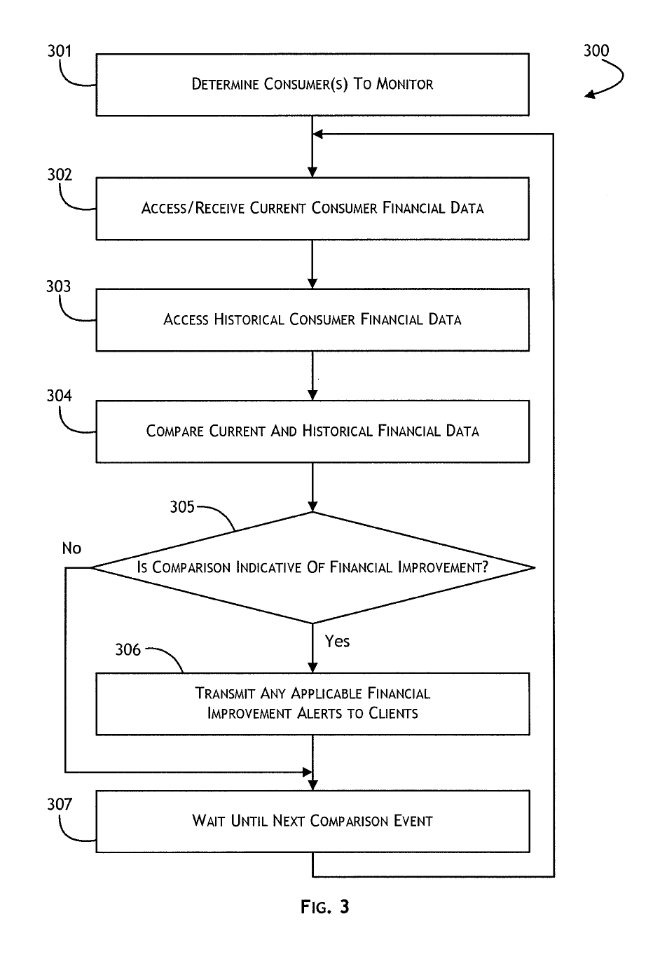

FIG. 3 shows a process 300 for monitoring historical and current credit data and generating an alert based on changes in consumer financial activity according to one embodiment. The process 300 may be implemented by the trigger module 150 using data from the financial database 162, the historical database 163, and the client 164. Depending on the embodiment, the method of FIG. 3 may include fewer or additional blocks and may be performed in a different order than is illustrated.

The process 300 begins at block 301 where one or more consumers are identified to be monitored. Consumers to be monitored may be determined, for example, based on a list file provided by a client 164. The client 164 may provide identifying data such as a consumer name, address, and/or social security number in order to identify each consumer. A web page stored on the computing system 100 may be accessed by the client 164 in order to provide consumer information in some embodiments. According to some embodiments, the computing system 100 monitors each consumer for which credit records are available. In an embodiment where all consumer financial data is stored as snapshots in the historical database 163, historical snapshots of consumer financial data may be available at initiation of a financial improvement monitor by the client 164,

Next, at block 302, current consumer financial data for the determined or selected consumer is accessed or received. In one embodiment, current credit data is maintained and may be accessed from the financial database 162. In some embodiments, current credit or financial data is obtained from a combination of data sources, such as the financial database 162, clients 164, demographic database 166, and/or one or more other data sources, and the data is maintained and saved by the computing system 100. In some embodiments, new data is obtained in real time when a client request is received, or when a periodic application of financial improvement triggers is performed.

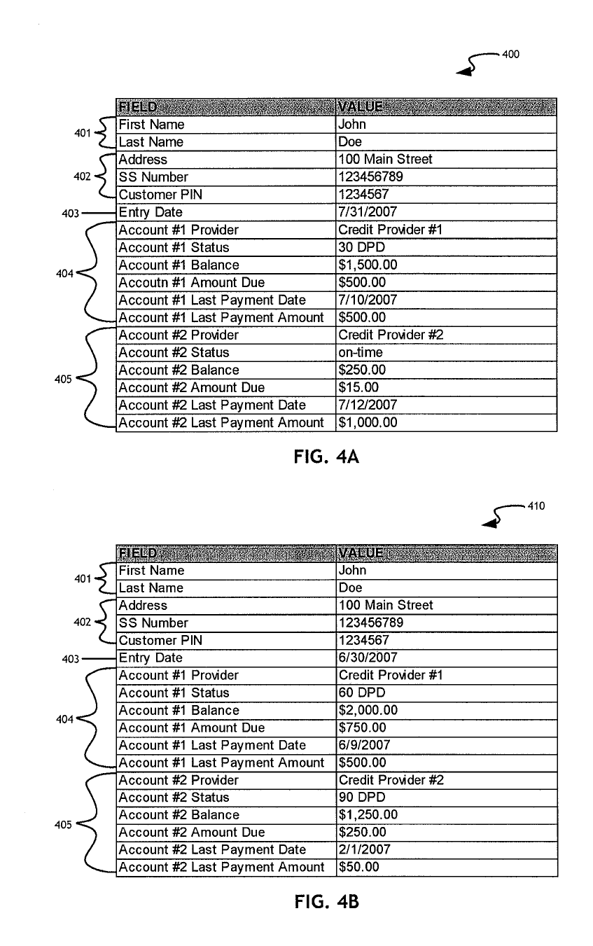

An example of a current financial record 400 stored in a financial database 162 is illustrated in FIG. 4A. In one embodiment, the financial record 400 comprises data from a credit report and/or other financial data sources. Exemplary current financial record 400 contains a number of fields, but alternative or additional fields may be stored in current financial record 400 according to some embodiments. In addition, financial data of consumers may be stored in any other suitable format, such as in text, spreadsheet, extensible markup, or database files, for example. As shown in FIG. 4A, the current financial record 400 comprises first and last name fields 401. In the example shown, the first name has a value of “John” and the last name has a value of “Doe.” The current financial record 400 further comprises consumer identification information 402 such as an address, social security number and a consumer PIN (e.g., a unique identification number).

Current financial record 400 further comprises an entry date field 403 identifying the date on which the current financial record 400 was stored. In the example shown, the entry date field 403 has a value of “Jul. 31, 2007.” The current financial record 400 may represent the most recent information corresponding to that consumer. As described above, data may be obtained in real time when a client request is made or when indicated by a predetermined schedule according to certain embodiments.

Current financial record 400 further comprises credit account No. 1 information 404 and credit account No. 2 information 405. Information related to two accounts is shown, but any number of accounts may be represented in the current financial record 400. The number of accounts listed may be dependent on the credit activity of the consumer, the number of accounts for which credit data is available, or any other parameters.

Credit account No. 1 information 404 includes the name of the credit provider (or some other identifier of the credit provider), the status of the credit account, the balance of the account, the amount due, the last payment date, and the last payment amount. The account information 400, 404 may correspond to respective credit card, loan, mortgage, revolving, or any other type of account associated with the consumer. The fields displayed in entry 400 or stored in entry 400 may vary based on the type of account. For the entry 400, the account No. 2 information 405 is similar to the account No. 1 information 404 except that the accounts are provided by different providers and different values populate these fields. In some embodiments, different fields may be used for different accounts depending on the type of account, the data available, or similar factors.

Referring again to the process 300 in FIG. 3, the historical credit data for the monitored consumer is accessed at block 303. Historical credit data may be accessed from historical database 163.

FIG. 4B shows a historical financial record 410 for the monitored consumer. The record 410 corresponds to a snapshot of financial data for the same consumer, “John Doe,” indicating financial data of John Doe at a previous point in time. Thus, the name fields 401 and the address, social security number, and customer PIN fields 402 are identical in each of the current financial record 100 and historical financial record 410. However, the entry date for the historical financial record 410 is “Jun. 30, 2007,” which is approximately one month before the Jul. 31, 2007 entry date of the current financial record 400. In other embodiments, historical financial record 410 may be from a different time period, for example, from 90 days or 180 days ago. Additionally, the historical database 163 may store multiple financial records for a particular consumer, such as monthly snapshots of the consumer's financial data over a period of several years.

At block 304, the historical consumer financial data, such as the historical financial data in the historical financial record 410, is compared to the current consumer financial data, such as the current financial data in the current financial record 400, such as by the trigger module 150 of the computing system 100 (FIG. 1). Thus, the trigger module compares current financial data to at least one snapshot of historical financial data. The historical record 410 comprises account information fields 404 and 405 that indicate the same account providers as in the current financial record 400. However, the account information has been updated in the current financial record 400 due to recent activity by the consumer. In the historical record 410, account No. 1 has the status of 60 days past due, and account No. 2 has the status of 90 days past due. However, by comparison to the current record 400, payments have been made and the accounts have been brought closer to on-time status. That is, as of Jul. 31, 2007, account No. 1 is now only 30 days past due, and account No. 2 is now on-time, as indicated in the current financial record 400.

Returning to FIG. 3, at decision block 305, the computing system 100 determines if the comparison is indicative of financial improvement by the consumer selected at block 301. Financial improvement may be, for example, bringing the accounts closer to being on-time, making a predetermined number of payments after a period of inactivity, increasing the amount of available credit by making payments, or any other activity that reflects the ability to make a new payment. A set of logical rules may be implemented to automatically determine whether a financial improvement exists. One example rule may be that whenever any account gets brought from 90 days or more past due to 60 days or less past due, a financial improvement trigger is activated and a corresponding alert is transmitted to the client. Any number of rules may be implemented. Different clients may use different rules. For example, one client may be interested in being alerted when any payments are made, while another client may only be interested in being alerted when one or more accounts are brought into on-time status.

Comparing the current financial record 400 with historical financial record 410 at block 304, the trigger module 150 determines that both account no. 1 and account no. 2 have been brought closer to on-time status, with account no. 2 now current in the current financial record 400 after being 90 days past due the previous month. This change could activate one or more financial improvement triggers based on the illustrative rules noted above. Furthermore, payments have been made between the time of entry 410 and entry 400. This activity may also be captured with additional rules. Some example rules include: bringing account from 90 days, 60 days, or 30 days past due to current and reducing account balances. While the consumer had previously been a non-paying consumer for these accounts, the consumer has now shown a willingness and ability to pay the amounts due on these accounts. This may indicate to other financial service providers having outstanding accounts with this consumer that collection efforts from the consumer should be renewed. If it is determined that the comparison is indicative of financial improvement and one or more rules were activated, then the process 300 continues to block 306. If the comparison at block 304 is not determined to be indicative of financial improvement at block 305, then the process 300 skips block 306 and proceeds to block 307.

At block 306, a client 164 that has requested alerts for detected consumer financial improvement is notified. Notification may come in the form of a report, an e-mail, an automatically generated letter, or any other format that informs the client of the event. The alert may include specific financial data related to the consumer, may indicate only that a particular rule has been activated, or may simply indicate the improvement. After the alert has been generated, the process 300 proceeds to block 307.

At block 307, the system waits until the next comparison event. For example, consumer credit records may be compared once every month, whenever the financial database is updated, when a client requests information, or at some other time or according to another schedule.

In another embodiment, financial improvement rules may monitor for opening of new accounts and/or closing of existing accounts. Thus, the comparison operation performed in block 304 may additionally include accessing utilities records to determine if the consumer has opened any new utilities accounts such as phone, internet, cable, electric, or gas. The opening of new utilities accounts may be indicative of financial improvement as well.

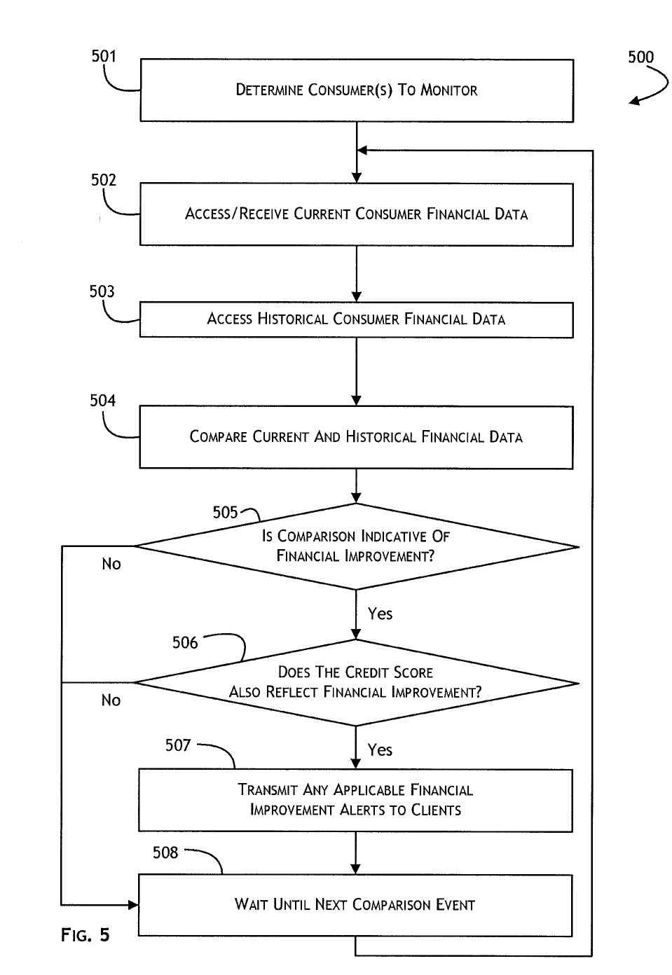

In an alternate embodiment, the trigger module 150 performs a different process 500 as shown in FIG. 5. Operations performed at blocks 501-505 are similar to those performed at blocks 301-305. In this alternate embodiment, at block 506, the trigger module 150 additionally determines whether a consumer whose credit or financial data has indicated financial improvement also has a credit score that indicates financial improvement. In one embodiment, the consumer's current credit score is compared to his or her historical credit score(s) that have been periodically stored in the historical database 163. If the improvement in the credit score is greater than a pre-defined threshold, the consumer is deemed to have made a financial improvement. In another embodiment, a consumer credit score that meets a pre-defined raw score threshold is deemed to have made financial improvement. The pre-defined threshold may be one point, two points, five points, ten points, twenty points, fifty points, one hundred points, two hundred points, or any other number of points that is needed to determine financial improvement.

Since a credit score is indicative of a consumer's overall financial health, this additional check may improve the predictive accuracy of the alerts. For example, if 1,000 consumer records meet the improvement criteria at block 505, the credit score check at block 506 may reduce the number of qualifying consumer records to, for example, 500. The alerts sent to the client at block 507 may include these 500 records. While the number of records is reduced, the client's likelihood to collect from these consumers is increased because their credit scores and individual account activities both reflect financial improvement.

### CONCLUSION

Accordingly, a system is described for monitoring credit activity for one or more consumers over a period of time. When it is determined that a consumer has experienced a positive financial improvement, as defined by client-specific and/or generic financial improvement rules, certain credit service providers are advantageously alerted to this activity so that they may seek payment for outstanding accounts.

While the above systems and methods have been described with reference to financial improvements, it will be understood that the invention is not limited to monitoring only improvements. As will be understood by a skilled artisan, financial data may be monitored as described herein, and other rules or triggers may be implemented in order to generate alerts for other activities. For example, clients may wish to be alerted when a client having previously had good standing begins to fall behind in payments to other providers.

All of the processes described above may be embodied in, and fully automated via, software code modules executed by one or more general purpose computers. The code modules may be stored in any type of computer-readable medium or other computer storage device. Some of all of the methods may alternatively be embodied in specialized computer hardware. In addition, the components referred to herein may be implemented in hardware, software, firmware, or a combination thereof.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

One skilled in the relevant art will appreciate that the methods and systems described above may be implemented by one or more computing devices, such as a memory for storing computer executable components for implementing the processes shown, as well as a process unit for executing such components. It will further be appreciated that the data and/or components described above may be stored on a computer readable medium and loaded into memory of computer device using a drive mechanism associated with a computer readable storing the computer executable components such as a CD-ROM, DVD-ROM, or network interface. Further, the component and/or data can be included in a single device or distributed in any manner.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A computer implemented method for generating an alert based on consumer financial data, the method comprising:
receiving from a financial service provider a request to monitor a consumer for financial improvements that are indicative of an increased likelihood that the consumer will pay an outstanding debt, the request comprising at least a name and address of a consumer for monitoring;
accessing first financial data associated with the consumer, the first financial data comprising data for each of one or more financial accounts associated with the consumer at a first time;
accessing second financial data associated with the consumer, the second financial data comprising data for each of one or more financial accounts associated with the consumer at a second time, wherein the second time is later than the first time;
comparing the first and second financial data to determine whether a predetermined difference exists between the first financial data and the second financial data, the predetermined difference representing an improvement in one or more of the financial accounts between the first time and the second time such that the consumer appears to be in a better position to make payments towards the outstanding debt; and
generating an alert for transmission to the financial service provider.

2. The computer implemented method of claim 1, wherein the request from the financial service provider comprises at least a name and address of each of a plurality of consumers.

3. The computer implemented method of claim 1, wherein the financial service provider is responsible for collecting the outstanding account balance from the consumer when the predetermined difference is determined to exist.

4. The computer implemented method of claim 1, wherein the comparing further comprises comparing the delinquent status of a first financial account in the first financial data and the delinquent status of the first financial account in of the second financial data.

5. The computer implemented method of claim 1, wherein the comparing further comprises comparing an account balance of a first financial account of the one or more financial accounts in the first financial data and the account balance of the first financial account in the second financial data.

6. The computer implemented method of claim 1, wherein the comparing further comprises comparing the recent payment status of a first financial account of the one or more financial accounts in the first financial data and the recent payment status of the first financial account in the second financial data.

7. The computer implemented method of claim 1, wherein each of the one or more financial accounts associated with the consumer are compared in the comparing step.

8. The computer implemented method of claim 1, wherein each financial account comprises one of: a credit account, a loan account, a real estate account, a revolving account, and an installment account.

9. The computer implemented method of claim 1, wherein the first time and the second time are separated by one of: one day, one week, one month, two months, three months, four month, six months, one year, two years, and five years.

10. The computer implemented method of claim 1, further comprising accessing third financial data associated with the consumer, the third financial data comprising data for each of one or more financial accounts associated with the consumer at a third time, wherein the third time is earlier than the first time and comparing at least the first and the third financial data to determine whether a predetermined difference exists between the first financial data and the third financial data, the predetermined difference representing an improvement in one or more of the financial accounts between the first time and the third time such that the consumer appears to be in a better position to make payments towards the outstanding debt.

11. A computer implemented method for generating alerts based on consumer financial activity, the method comprising:
receiving a list of a plurality of consumers for monitoring;
accessing first financial account data and credit scores of the plurality of consumers at a first time;
accessing second financial account data and credit scores of the plurality of consumers at a second time, wherein the second time is later than the first time;
for each consumer of the plurality of consumers:
determining whether a difference between the second financial account data and the first financial account data meets one or more pre-defined rules indicative of an improvement in the financial health of the consumer; and
adding the consumer to a list of alerts if the financial account data comparison indicates financial improvement;
removing consumers from the list of alerts if a comparison of the consumer's credit score at the second time and the consumer's credit score at the first time does not indicate financial improvement; and
sending the filtered list of alerts.

12. The computer implemented method of claim 11, wherein the determining further comprises detecting the presence of new utilities accounts in the second financial account data.

13. The computer implemented method of claim 11, wherein the filtering further comprises:
determining, for each consumer on the list of alerts, whether the difference between the second credit score and the first credit score meets a pre-defined threshold indicative of an improvement in the financial health of the consumer.

14. The computer implemented method of claim 13, wherein the pre-defined threshold is a difference selected from the group comprising: one point, two points, five points, ten points, and twenty points.

15. The computer implemented method of claim 11, wherein the filtering further comprises:
determining, for each consumer on the list of alerts, whether the second credit score meets a pre-defined score threshold.

16. A computer system for generating alerts based on consumer financial activity, comprising:
a financial database that stores current financial data;
a historical database that stores historical credit data;
a trigger module configured to:
receive a list of consumers to monitor;
access the financial database on a periodic basis and retrieve the current financial data for consumers on the list;
for each consumer, compare the current financial data against the historical financial data stored in the historical database to determine if any differences in the current and historical financial data are indicative of financial improvement for the consumer; and
generate a financial improvement alert indicating those zero or more consumers for which the current and historical financial data are indicative of financial improvement.

17. The computer system of claim 16, wherein the trigger module is configured to compare, for at least some of the consumers on the list, a delinquent status of an account in the current financial data and a delinquent status of the account in the historical financial data.

18. The computer system of claim 16, wherein the trigger module is configured to compare, for at least some of the consumers on the list, an account balance of an account in the current financial data and an account balance of the account in the historical financial data.

19. The computer system of claim 16, wherein the trigger module is configured to detect, for at least some of the consumers on the list, the presence of new utilities accounts in the current credit data.

20. The computer system of claim 16, wherein the trigger module is configured to compare, for at least some of the consumers on the list, the consumer's credit score in the current credit data and the consumer's credit score in the historical credit data and send the alert if the credit score comparison indicates financial improvement.

21. The computer system of claim 16, wherein the trigger module is configured to periodically copy the current credit data from the financial database to the historical database.

22. A computer-readable medium having stored thereon executable code which, when executed by a host system, causes the host system to:
access first financial data associated with one or more financial accounts of a consumer at a first time;
access second financial data associated with one or more financial account at a second time;
compare the first and second financial data to determine whether a predetermined difference exists between the first financial data and the second financial data, the predetermined difference representing an improvement in the consumer's likelihood to make payments towards an outstanding account balance; and
generate an alert indicating the financial improvement.

23. The computer-readable medium of claim 22, wherein the executable code that causes the host system to generate an alert further comprises:
executable code that causes the host system to compare the consumer's credit score obtained at the first time and the consumer's credit score obtained at the second time; and
executable code that causes the host system to send the alert if the comparison of the credit scores indicates financial improvement.
